(19) United States
(12) Patent Application Publication
(10) Pub. No.: US 2007/0227135 A1
(43) Pub. Date: Oct. 4, 2007

(54) Integrated load-sensing hydraulic system

(75) Inventor: Rabie E. Khalil, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/392,771

(22) Filed: Mar. 30, 2006

(51) Int. Cl. F16D 31/02

(52) U.S. Cl. 60/420

(57) ABSTRACT

A hydraulic system for a machine having a work tool is disclosed. The hydraulic system has a tank configured to hold a supply of fluid, and a source configured to pressurize the fluid from the tank. The hydraulic system also has a first hydraulic actuator configured to receive pressurized fluid from the source and effect movement of the work tool, and a second hydraulic actuator configured to receive pressurized fluid from the source and effect steering of the machine. The hydraulic system additionally has at least one operator interface device configured to receive pressurized fluid from the source and selectively meter the pressurized fluid to a control valve to effect movement of the control valve.

### U.S. GOVERNMENT RIGHTS

This invention was made with government support under the terms of Contract No. DE-FC36-01GO11095 awarded by the Department of Energy. The government may have certain rights in this invention.

### TECHNICAL FIELD

The present disclosure relates generally to a hydraulic system and, more particularly, to an integrated hydraulic system having load-sensing capabilities.

### BACKGROUND

Machines such as motor graders, wheel loaders, backhoes, excavators, haul trucks, and other machines known in the art often include multiple separate hydraulic systems. For example, a machine may include an implement system that utilizes pressurized fluid to move a work tool of the machine, and a steering system having one or more hydraulic actuators associated with a traction device to effect maneuvering of the machine. The machine may also include a brake system that decelerates the machine, a hydraulic drive system for propelling the machine, and a cooling system that cools the fluid circulated through each of the machine's hydraulic systems. Each of these separate systems may include a fluid-pressurizing pump that derives power from the machine's primary power source and generates an associated efficiency loss for the power source.

In order to minimize the efficiency loss of the power source and overall cost of the machine, some of the separate systems may be integrated to receive pressurized fluid from a single common pump. One such integrated system is described in U.S. Pat. No. 4,663,936 (the '936 patent) issued to Morgan on May 12, 1987. The '963 patent describes a flow control system having a common engine-driven pump, a load sensing priority flow control valve, a priority load circuit for supplying pressurized fluid to a steering cylinder, and an auxiliary load circuit for powering a hydraulic cylinder. In order to prevent stalling of the engine during low engine speed situations, flow through the auxiliary load circuit is unrestricted, thereby preventing actuation of the hydraulic cylinder. During high engine speed situations, flow through the auxiliary load circuit is restricted to increase the pressure therein allowing actuation of the hydraulic cylinder.

Although the flow control system of the '936 patent may lower machine efficiency losses by providing a single pump that is common to two separate fluid circuits, the pump of the '936 patent could be operated more efficiently. Specifically, because the output of the pump is not controlled according to system load, but instead is directly related to engine speed, there may be situations where the output of the pump exceeds system demand. In these situations, efficiency losses associated with the fluid system of the '936 patent may increase. In addition, during situations of low engine speed, operation of the hydraulic cylinder may be inconveniently impossible. Further, although the flow control system of '936 patent may eliminate one pump from the engine, there may be additional pumps associated with other systems of the engine that are inefficiently separate from the integrated flow control system.

The disclosed hydraulic system is directed to overcoming one or more of the problems set forth above.

### SUMMARY OF THE INVENTION

In one aspect, the present disclosure is directed to a hydraulic system for a machine having a work tool. The hydraulic system includes a tank configured to hold a supply of fluid, and a source configured to pressurize the fluid from the tank. The hydraulic system also includes a first hydraulic actuator configured to receive pressurized fluid from the source and effect movement of the work tool, and a second hydraulic actuator configured to receive pressurized fluid from the source and effect steering of the machine. The hydraulic system additionally includes at least one operator interface device configured to receive pressurized fluid from the source and selectively meter the pressurized fluid to a control valve to effect movement of the control valve.

In another aspect, the present disclosure is directed to a hydraulic system for a machine having a traction device. The hydraulic system includes a tank configured to hold a supply of fluid, and a source configured to pressurize the fluid from the tank. The hydraulic system also includes a hydraulic braking mechanism configured to receive pressurized fluid from the source and effect deceleration of the traction device. The hydraulic system additionally includes a hydraulic drive motor associated with a transmission unit and being configured to receive pressurized fluid from the source.

In yet another aspect, the present disclosure is directed to a method of operating a hydraulic system. The method includes pressurizing a fluid within a common circuit, and directing the pressurized fluid to a first hydraulic actuator within the common circuit to effect movement of a work tool. The method also includes directing the pressurized fluid to a second hydraulic actuator within the common circuit to effect steering of a machine, and directing the pressurized fluid to at least one operator interface device within the common circuit. The method further includes selectively metering pressurized fluid from the at least one operator interface device to effect movement of a control valve.

In yet another aspect, the present disclosure is directed to another method of operating a hydraulic system. The method includes pressurizing a fluid within a circuit and directing the pressurized fluid from the circuit to a hydraulic braking mechanism to effect deceleration of a traction device. The method also includes directing the pressurized fluid from the circuit to a hydraulic drive motor associated with a transmission unit.

### BRIEF DESCRIPTION OF THE DRAWINGS

FIG. 1 is a diagrammatic illustration of an exemplary disclosed machine; and

FIG. 2 is a schematic illustration of an exemplary disclosed hydraulic system for the machine of FIG. 1.

### DETAILED DESCRIPTION

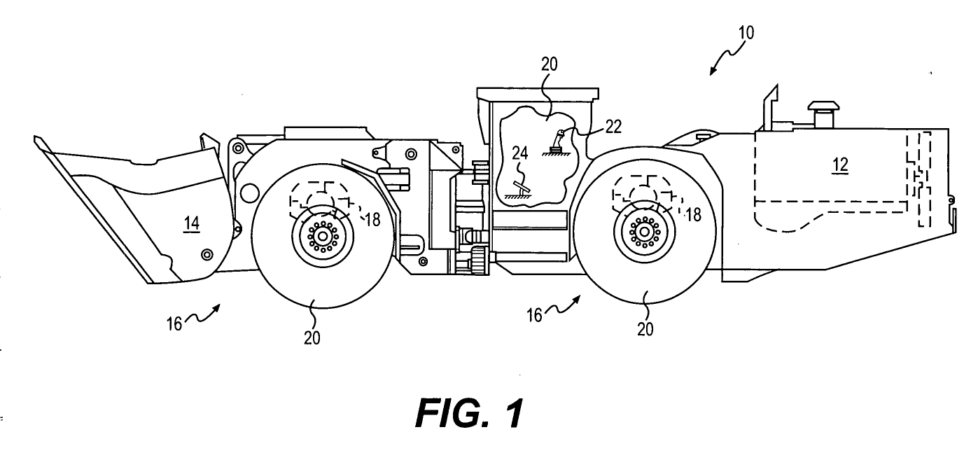

FIG. 1 illustrates an exemplary machine 10. Machine 10 may be a mobile machine that performs some type of operation associated with an industry such as mining, construction, farming, transportation, or any other industry known in the art. For example, machine 10 may embody the “load-haul-dump” wheel loader depicted in FIG. 1, a conventional wheel loader, a motor grader, a backhoe, an excavator, a passenger vehicle, or any other machine known in the art. Machine 10 may include a power source 12, a work tool 14, at least one traction device 16, at least one brake mechanism 18, and an operator station 20.

Power source 12 may embody an internal combustion engine such as, for example, a diesel engine, a gasoline engine, a gaseous fuel-powered engine such as a natural gas engine, or any other type of engine apparent to one skilled in the art. Power source 12 may alternatively embody another source of power such as a fuel cell, a power storage device, or any other suitable source of power.

Numerous different work tools 14 may be attachable to a single machine 10 and controllable from operator station 20. Work tool 14 may include any device used to perform a particular task such as, for example, a bucket, a fork arrangement, a blade, a shovel, a ripper, a dump bed, a broom, a snow blower, a propelling device, a cutting device, a grasping device, or any other task-performing device known in the art. Work tool 14 may be connected to machine 10 via a direct pivot, via a linkage system, via one or more hydraulic cylinders, via a motor, or in any other appropriate manner. Work tool 14 may be configured to pivot, rotate, slide, swing, lift, or move relative to machine 10 in any way known in the art.

Traction device 16 may include wheels 21 located on each side of machine 10 (only one side shown) and configured to support machine 10. Alternately, traction device 16 may include tracks, belts or other similar traction devices. It is contemplated that any of wheels 21 on machine 10 may be steerable for maneuvering of machine 10 and/or driven to propel machine 10.

Brake mechanism 18 may be configured to retard the motion of machine 10 and may be operably associated with one or more wheels 21 of machine 10. In one embodiment, brake mechanism 18 may include a hydraulic pressure-actuated wheel brake such as, for example, a disk brake or a drum brake that is disposed intermediate wheel 21 and a final drive assembly (not shown) of machine 10. When actuated, pressurized fluid within brake mechanism 18 may be utilized to increase the rolling friction of machine 10.

Operator station 20 may be configured to receive input from a machine operator indicative of a desired work tool or machine movement. Specifically, operator station 20 may include one or more operator interface devices 22 embodied as single or multi-axis joysticks located proximal an operator seat, and one or more brake pedals 24. Each operator interface device 22 may be a proportional-type controller configured to position or orient work tool 14 or machine 10 by passing a flow of pilot fluid to a control valve at a rate indicative of a desired velocity. Similarly, brake pedal 24 may be associated with brake mechanism 18 for manual control of brake mechanism 18. As brake pedal 24 is depressed by a machine operator, pressurized fluid may be directed to brake mechanism 18 such that a degree of brake pedal actuation proportionally controls a pressure of the fluid supplied to brake mechanism 18. It is contemplated that additional and/or different operator interface devices may be included within operator station 20, if desired, such as, for example, wheels, knobs, push-pull devices, switches, and other operator interface devices known in the art.

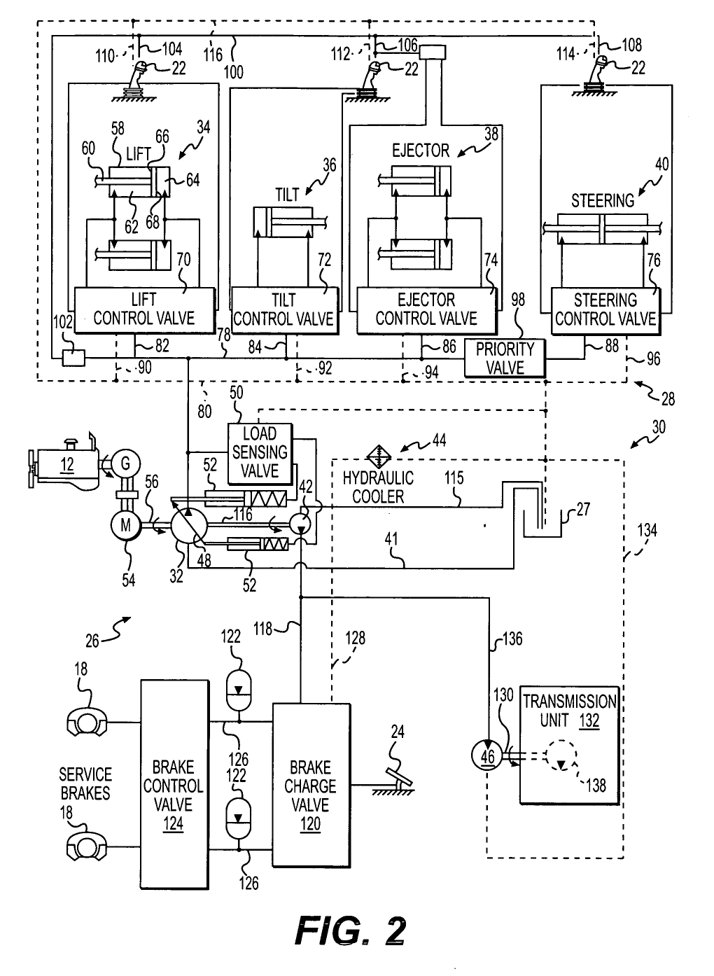

As illustrated in FIG. 2, machine 10 may also include a hydraulic control system 26 having a plurality of fluid components that cooperate to move work tool 14, steer and drive wheels 21, and actuate brake mechanisms 18. Specifically, hydraulic control system 26 may include a tank 27 holding a supply of fluid, a first circuit 28 and a second circuit 30 both configured to draw fluid from and return fluid to tank 27. First circuit 28 may include a source 32 configured to pressurize a first flow of fluid drawn from tank 27 and to direct the pressurized fluid to a pair of lift cylinders 34, a tilt cylinder 36, a pair of ejector cylinders 38, and a steering cylinder 40.

Tank 27 may constitute a reservoir configured to hold a supply of fluid. The fluid may include, for example, a dedicated hydraulic oil, an engine lubrication oil, a transmission lubrication oil, or any other fluid known in the art. One or more hydraulic systems within machine 10 may draw fluid from and return fluid to tank 27. It is also contemplated that hydraulic control system 26 may alternatively be connected to multiple separate fluid tanks, if desired.

Source 32 may embody a variable delivery pump such as a swashplate-type pump configured to draw fluid from tank 27 via a passageway 41 and produce a flow of pressurized fluid, wherein an angle of a swashplate 48 corresponds to a displacement of associated pump pistons (not shown). A load sensing valve 50 may selectively communicate fluid exiting source 32 and fluid returning to tank 27 with one or more actuators 52 operatively linked to swashplate 48 such that the angle of swashplate 48 may be controlled in response to a load on source 32. Source 32 may alternatively embody a metering sleeve-type pump wherein a position of a metering sleeve (not shown) corresponds to a delivery rate of the pump, or any other type of variable delivery pump known in the art. Source 32 may be drivingly connected to an electric motor 54 of machine 10 by, for example, a countershaft 56 such that an output rotation of motor 54 results in a corresponding input rotation of source 32. Alternatively, source 32 may be indirectly connected to motor 54 via a torque converter (not shown), via a gear box (not shown), or in any other manner known in the art.

Because lift cylinders 34, tilt cylinder 36, ejector cylinders 38, and steering cylinder 40 are similar in makeup and function, the description of hydraulic control system 26 will be made with reference to only lift cylinders 34. It is to be noted, however, that the description of lift cylinders 34 may be just as applicable to tilt cylinder 36, ejector cylinders 38, and steering cylinder 40. In addition, the description of lift cylinders 34 may be similarly applicable to a swing actuator (not shown) that may function to swing work tool 14 relative machine 10, or to any other suitable hydraulic actuator.

Lift cylinders 34 may each be connected to a frame of machine 10 via a direct pivot, via a linkage system with lift cylinders 34 forming members in the linkage system, or in any other appropriate manner. As illustrated in FIG. 2, each lift cylinder 34 may include a tube 58 and a piston assembly 60 disposed within tube 58. Tube 58 may be divided by piston assembly 60 into a first chamber 62 and a second chamber 64. First and second chambers 62, 64 may be selectively supplied with pressurized fluid from source 32 and selectively connected with tank 27 to cause piston assembly 60 to displace within tube 58, thereby changing the effective length of lift cylinder 34. The expansion and retraction of lift cylinder 34 may assist in moving work tool 14 (or, in the case of steering cylinder 40, may assist in steering wheels 21 or articulating machine 10).

Piston assembly 60 may be axially aligned with and disposed within tube 58, and may include a first hydraulic surface 66 and a second hydraulic surface 68 disposed opposite first hydraulic surface 66. An imbalance of force caused by fluid pressure on first and second hydraulic surfaces 66, 68 may result in movement of piston assembly 60 within tube 58. For example, a force on first hydraulic surface 66 being greater than a force on second hydraulic surface 68 may cause piston assembly 60 to retract within tube 58 to decrease the effective length of lift cylinder 34. Similarly, when a force on second hydraulic surface 68 is greater than a force on first hydraulic surface 66, piston assembly 60 may displace to increase the effective length of lift cylinder 34. A flow rate of fluid into and out of first and second chambers 62 and 64 may correspond with a velocity of lift cylinder 34, while a pressure of the fluid in contact with first and second hydraulic surfaces 66 and 68 may correspond with an actuation force of lift cylinder 34. A sealing member (not shown), such as an o-ring, may be connected to piston assembly 60 to restrict a flow of fluid between an internal wall of tube 58 and an outer cylindrical surface of piston assembly 60.

Each of lift, tilt, ejector, and steering cylinders 34-40 may include an associated control valve to regulate the motion of their related fluid actuators. Specifically, lift cylinder 34 may be associated with a lift control valve 70; tilt cylinder 36 may be associated with a tilt control valve 72; ejector cylinder 38 may be associated with an ejector control valve 74; and steering cylinder 40 may be associated with a steering control valve 76. Each of these control valves may be connected to allow pressurized fluid to flow to and drain from their respective actuators via common passageways. In particular, each of control valves 70-76 may be connected in parallel to source 32 by way of a common supply passageway 78 and individual fluid passageways 82, 84, 86, and 88, respectively. Similarly, each of control valves 70-76 may be connected in parallel to tank 27 by way of a common drain passageway 80 and individual fluid passageways 90, 92, 94, and 96, respectively. A priority valve element 98 may be disposed within common supply passageway 78, between individual fluid passageways 86 and 88, to provide priority in flow distribution to steering cylinder 40 over lift, tilt, and ejector cylinders 34-38. In other words, the flow from source 32 may first be directed to steering cylinder 40, leaving any remaining flow to be divided amongst lift, tilt, and ejector cylinders 34-38.

Because the elements of control valves 70-76 may be similar and function in a related manner, the operation of only lift control valve 70 will be discussed in this disclosure. In one example, lift control valve 70 may include a first chamber supply element (not shown), a first chamber drain element (not shown), a second chamber supply element (not shown), and a second chamber drain element (not shown). The first and second chamber supply elements may be connected in parallel to individual fluid passageway 82 to fill their respective chambers with fluid from source 32, while the first and second chamber drain elements may be connected in parallel to individual fluid passageway 90 to drain the respective chambers of fluid. To extend lift cylinders 34, first chamber supply element may be moved to allow the pressurized fluid from source 32 to fill the first chambers of lift cylinders 34 with pressurized fluid via individual fluid passageway 82, while the second chamber drain element may be moved to drain fluid from the second chambers of lift cylinders 34 to tank 27 via individual fluid passageway 90. To move lift cylinders 34 in the opposite direction, the second chamber supply element may be moved to fill the second chambers of lift cylinders 34 with pressurized fluid, while the first chamber drain element may be moved to drain fluid from the first chambers of lift cylinders 34. It is contemplated that both the supply and drain functions may alternatively be performed by a single element associated with the first chamber and a single element associated with the second chamber, or a single element associated with both the first and second chambers, if desired.

The supply and drain elements of control valves 70-76 may be pilot operated to move against a spring bias in response to an operator manipulation of interface devices 22. In particular, pressurized fluid from source 32 may be directed from common supply passageway 78 to a common pilot supply passageway 100 by way of a pilot control valve 102. Each operator interface device 22 may receive pilot fluid from common pilot supply passageway 100 via individual pilot supply passageways 104, 106, and 108, respectively, and pass the pilot fluid to the appropriate control valves in response to an operator manipulation. Each operator interface device 22 may also drain pilot fluid from the appropriate control valves to tank 27 via individual pilot drain passageways 110, 112, and 114, a common pilot drain passageway 116, and common drain passageway 80 in response to the operator manipulation. In this manner, the elements of lift, tilt, ejector, and steering control valves 70-76 may be moved to specific flow passing positions that correspond to the tilt angle of operator interface devices 22 and result in a desired velocity of the associated cylinder.

Second circuit 30 may also include a source 42 configured to pressurize fluid drawn from tank 27 via a supply passageway 115, and direct the pressurized fluid to brake mechanisms 18, a hydraulic cooler 44, and a drive motor 46. Source 42 may embody a fixed displacement pump configured to produce a flow of pressurized fluid proportional to a rotational input speed. Source 42 may be drivably connected to source 32 by, for example, a countershaft 116 such that an output rotation of source 32 results in a corresponding input rotation of source 42. Alternatively, source 42 may be directly driven by electric motor 54, if desired. It is contemplated that source 42 may or may or may not be a fixed delivery pump (e.g., a pump that delivers a constant flow rate of pressurized fluid per input revolution).

Pressurized fluid from source 42 may be directed to brake mechanisms 18 by way of a supply passageway 118. A brake charging valve 120, one or more accumulators 122, and a brake control valve 124 may be associated with brake mechanisms 18 and configured to regulate the flow of pressurized fluid from supply passageway 118 to brake mechanisms 18. Specifically, each accumulator 122 may be fluidly connected to an associated brake mechanism 18 by way of a fluid passageway 126. Accumulators 122 may be selectively filled with pressurized fluid from supply passageway 118 via brake charging valve 120 in anticipation of brake actuation. Brake control valve 124 may embody an open center type valve disposed within fluid passageways 126 between brake mechanisms 18 and accumulators 122 and selectively actuated in response to operator manipulation of brake pedal 24 to either direct pressurized fluid from accumulators 122 to brake mechanisms 18 causing deceleration of machine 10, or to drain the pressurized fluid from brake mechanisms 18 to tank 27 via a passageway (not shown), thereby stopping the deceleration of machine 10.

Hydraulic cooler 44 may be disposed with a drain passageway 128 between brake charging valve 120 and tank 27 to cool the fluid flowing through brake charging valve 120. Hydraulic cooler 44 may embody a heat exchanger such as, for example, an air-to-liquid heat exchanger or a liquid-to-liquid heat exchanger configured to facilitate the transfer of heat from the fluid of hydraulic control system 26 to a transfer medium. For example, hydraulic cooler 44 may embody a tube and shell type heat exchanger, a corrugated plate type heat exchanger, a tube and fine type heat exchanger, or any other type of heat exchanger known in the art. Because source 42 may be a fixed displacement pump, fluid may always flow through brake charging valve 120 to hydraulic cooler 44, even when brake mechanisms 18 are not draining. In this manner, hydraulic cooler 44 may function to continuously cool the fluid within hydraulic control system 26, regardless of brake actuation.

Drive motor 46 may be connected to supply passageway 118 via a passageway 136 and driven by a fluid pressure differential to rotate a pumping mechanism 138 associated with a transmission unit 132. Specifically, drive motor 46 may include a first and a second chamber (not shown) located to either side of an impeller (not shown). When the first chamber is filled with pressurized fluid and the second chamber is drained of fluid, the impeller may be urged to rotate in a first direction. Conversely, when the first chamber is drained of fluid and the second chamber is filled with pressurized fluid, the impeller may be urged to rotate in an opposite direction. The flow rate of fluid into and out of the first and second chambers may determine an output rotational velocity of drive motor 46, while a pressure differential across the impeller may determine an output torque. Drive motor 46 may be connected to pumping mechanism 138 by way of a countershaft 130 and such that an output rotation of drive motor 46 results in a corresponding action of pumping mechanism 138.

Transmission unit 132 may embody, for example, a reducing mechanism associated with traction device 16. In particular, transmission unit 132 may be configured to couple an output of power source 12 to drive traction devices 16 and selectively increase or decrease the rotation ratio of traction devices 16 to that of power source 12 by a predetermined amount. Pumping mechanism 138 may function to circulate cooling fluid through transmission unit 132 and a transmission heat exchanger (not shown), thereby transferring heat away from transmission unit 132. It is contemplated that pumping mechanism 138 and transmission unit 132 may be omitted from second circuit 30, if desired. After exiting drive motor 46, return fluid may drain to tank 27 by way of drain passageway 134.

### INDUSTRIAL APPLICABILITY

The disclosed hydraulic system finds potential application in any machine where it is desirable to join multiple hydraulic circuits and utilize common pumps. The disclosed hydraulic system may improve efficiency of a machine by reducing the number of fluid pumps driven by a power source and by controlling an output of one or more of the pumps according to a system load. Operation of hydraulic control system 26 will now be described.

As source 32 of first circuit 28 pressurizes fluid drawn from tank 27, the pressurized fluid may be directed through common supply passageway 78 and control valves 70-76 to lift cylinders 34, tilt cylinder 36, ejector cylinders 38, and steering cylinder 40. If the pressure or the flow rate of the fluid from source 32 falls below a predetermined threshold value, priority valve element 98 may move to divert a greater portion of the flow from cylinders 34-38 to steering cylinder 40. Simultaneous to the direction of pressurized fluid to cylinders 34-40, fluid from common supply passageway 78 may be directed to operator interface devices 22 via pilot control valve 102 and common pilot supply passageway 100. The manipulation of operator interface devices 22 may then result in the pilot fluid from common pilot supply passageway 100 flowing to selective valve elements of control valves 70-76, thereby selectively initiating actuation of cylinders 34-40 at a corresponding desired velocity.

The loading of first circuit 28 may control the output of source 32. That is, pressurized fluid indicative of the loading on cylinders 34-40 may be redirected back to actuators 52 associated with swashplate 48 of source 32 via load sensing valve 50. Load sensing valve 50 may then use the pressure of the redirected fluid to control the angle of swashplate 48 and thus the output of source 32.

As source 32 of first circuit 28 is rotated by motor 54, source 42 of second circuit 30 may also be driven to pressurize fluid drawn from tank 27. The pressurized fluid from source 42 may be directed through supply passageway 118 to drive motor 46 and to brake mechanisms 18 by way of brake charging valve 120, accumulators 122, and brake control valve 124. Thereafter the fluid may be recirculated back to tank 27. However, prior to reaching tank 27, the flow of return fluid from brake charging valve 120 may be directed through hydraulic cooler 44, where the fluid may be cooled to a predetermined temperature. Because tank 27 may be common to both first and second circuits 28, 30, hydraulic cooler 44 may reduce the temperature of the fluid within both circuits.

Hydraulic control system 26 may improve efficiency and lower the cost of machine 10 by integrating multiple hydraulic circuits. In particular, by combining an implement system (cylinders 34-38), a steering system (cylinder 40), and a pilot fluid system (pilot fluid supplied to operator interface devices 22) into a single circuit (first circuit 28) powered by a common source (source 32), two sources may be eliminated from machine 10. In addition, by combining a braking system (brake mechanisms 18), a fluid cooling system (hydraulic cooler 44), and a drive system (drive motor 46) into a single circuit (second circuit 30) powered by a common source (source 42), two more sources may be eliminated from power source 12. Further, because both sources 32 and 42 may be driven by common motor 54, additional driving components of machine 10 may be eliminated. Also, because source 32 may embody a variable delivery type of pump with load sensing capabilities, source 32 may only be operated as necessary, further improving the efficiency of machine 10 while ensuring operation of cylinders 34-40 under a range of conditions. Additionally, because source 42 may embody a fixed delivery type of pump the fluid of hydraulic control system 26 may be continuously circulated through hydraulic cooler 44 for consistent cooling of the fluid, regardless of other operations performed by the same fluid circuit.

It will be apparent to those skilled in the art that various modifications and variations can be made to the hydraulic system of the present disclosure. Other embodiments of the hydraulic system will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A hydraulic system for a machine having a work tool, comprising:
a tank configured to hold a supply of fluid;
a source configured to pressurize the fluid from the tank;
a first hydraulic actuator configured to receive pressurized fluid from the source and effect movement of the work tool;
a second hydraulic actuator configured to receive pressurized fluid from the source and effect steering of the machine; and
at least one operator interface device configured to receive pressurized fluid from the source and selectively meter the pressurized fluid to a control valve to effect movement of the control valve.

2. The hydraulic system of claim 1, wherein movement of the control valve affects filling and draining of the first hydraulic actuator.

3. The hydraulic system of claim 1, wherein movement of the control valve affects filling and draining of the second hydraulic actuator.

4. The hydraulic system of claim 1, wherein the source is a variable delivery pump.

5. The hydraulic system of claim 4, further including a load-sensing valve in fluid communication with the source and configured to control a delivery of the source in response to a load on the hydraulic system.

6. The hydraulic system of claim 1, further including a priority valve configured to give flow priority to the second hydraulic actuator.

7. The hydraulic system of claim 1, further including a pilot control valve configured to regulate the flow of pressurized fluid from the source to the operator interface device.

8. The hydraulic system of claim 1, further including an electric motor configured to drive the source.

9. The hydraulic system of claim 1, further including:
a second source configured to pressurize the fluid from the tank;
a hydraulic braking mechanism configured to receive pressurized fluid from the second source and effect deceleration of a traction device; and
a hydraulic motor associated with a transmission unit and being configured to receive pressurized fluid from the second source.

10. The hydraulic system of claim 9, wherein the source and the second source are operatively connected to a common countershaft.

11. The hydraulic system of claim 9, further including a hydraulic cooler configured to cool the pressurized fluid from the second source before it drains to the tank.

12. The hydraulic system of claim 11, wherein the second source is a fixed delivery pump configured to direct a flow of pressurized fluid though the hydraulic cooler during operation of the machine.

13. The hydraulic system of claim 11, wherein the hydraulic cooler is disposed between the hydraulic braking mechanism and the tank.

14. The hydraulic system of claim 9, further including:
a brake charging valve disposed between the source and the hydraulic braking mechanism;
at least one accumulator in selective fluid communication with the brake charging valve and the hydraulic braking mechanism; and
a brake control valve disposed between the at least one accumulator and the hydraulic braking mechanism.

15. A hydraulic system for a machine having a traction device, comprising:
a tank configured to hold a supply of fluid;
a source configured to pressurize the fluid from the tank;
a hydraulic braking mechanism configured to receive pressurized fluid from the source and effect deceleration of the traction device; and
a hydraulic motor configured to receive pressurized fluid from the second source and drive a transmission pump for circulating cooling fluid through a transmission unit.

16. The hydraulic system of claim 15, further including a hydraulic cooler configured to cool the pressurized fluid from the source before it drains to the tank.

17. The hydraulic system of claim 16, wherein the source is a fixed delivery pump configured to direct a flow of pressurized fluid though the hydraulic cooler during operation of the machine.

18. The hydraulic system of claim 16, wherein the hydraulic cooler is disposed between the hydraulic braking mechanism and the tank.

19. The hydraulic system of claim 15, further including:
a brake charging valve disposed between the source and the hydraulic braking mechanism;
at least one accumulator in selective fluid communication with the brake charging valve and the hydraulic braking mechanism; and
a brake control valve disposed between the at least one accumulator and the hydraulic braking mechanism.

20. A method of operating a hydraulic system, comprising:
pressurizing a fluid within a common circuit;
directing the pressurized fluid to a first hydraulic actuator within the common circuit to effect movement of a work tool;
directing the pressurized fluid to a second hydraulic actuator within the common circuit to effect steering of a machine;
directing the pressurized fluid to at least one operator interface device within the common circuit; and
selectively metering pressurized fluid from the at least one operator interface device to effect movement of a control valve.

21. The method of claim 20, wherein movement of the control valve affects filling and draining of at least one of the first and second hydraulic actuators.

22. The method of claim 20, further including:
sensing a load on the hydraulic system; and
in response to the sensed load, varying a rate at which the fluid is pressurized.

23. The method of claim 20, wherein directing the pressurized fluid to the first and second hydraulic actuators includes:
first directing the pressurized fluid to the second hydraulic actuator; and
then directing a remaining flow of the pressurized fluid to the first hydraulic actuator.

24. The method of claim 20, further including regulating the flow of pressurized fluid to the at least one operator interface device.

25. The method of claim 20, further including:
pressurizing a fluid within a second circuit;
directing the pressurized fluid from the second circuit to a hydraulic braking mechanism to effect deceleration of a traction device; and
directing the pressurized fluid from the second circuit to a hydraulic drive motor associated with a transmission unit.

26. The method of claim 25, further including driving a source of the pressurized fluid in the second circuit with the source of pressurized fluid in the common circuit.

27. The method of claim 25, further including cooling the pressurized fluid in the second circuit.

28. The method of claim 27, wherein cooling the fluid in the second circuit results in cooling of the fluid in the first circuit.

29. A method of operating a hydraulic system, comprising:
pressurizing a fluid within a circuit;
directing the pressurized fluid from the circuit to a hydraulic braking mechanism to effect deceleration of a traction device;
directing the pressurized fluid from the circuit to a hydraulic drive motor coupled to a transmission pump; and
driving the transmission pump to circulate cooling fluid through the transmission unit.

30. The method of claim 29, further including cooling the pressurized fluid in the circuit.

31. A machine having a work tool, the machine comprising:
a power source configured to produce a power output;
at least one traction device configured to propel the machine;
a tank configured to hold a supply of fluid;
a variable delivery pump operatively driven by the power source and configured to pressurize the fluid from the tank;
a first hydraulic actuator configured to receive pressurized fluid from the variable delivery pump and effect movement of the work tool;
a second hydraulic actuator configured to receive pressurized fluid from the variable delivery pump and effect steering of the machine;
at least one operator interface device configured to receive pressurized fluid from the variable delivery pump and selectively meter the pressurized fluid to a control valve to effect movement of the control valve;
a fixed delivery pump operatively driven by the first source and configured to pressurize the fluid from the tank;
a hydraulic braking mechanism configured to receive pressurized fluid from the fixed delivery pump and effect deceleration of the machine;
a hydraulic drive motor associated with a transmission unit and being configured to receive pressurized fluid from the fixed delivery pump; and
a hydraulic cooler configured to cool the pressurized fluid from the fixed delivery pump before it drains to the tank.
